(19) United States
(12) Patent Application Publication
(10) Pub. No.: US 2022/0080237 A1
(43) Pub. Date: Mar. 17, 2022

(54) An Apparatus and Method for Firefighting

(71) Applicant: Aerospace Holdings Inc., Cheyenne, WY (US)

(72) Inventors: Alexandru PREDONU, Ilfov (RO); Dacian Ioan VINEREANU, Bucharest (RO)

(73) Assignee: Aerospace Holdings Inc., Cheyenne, WY (US)

(21) Appl. No.: 17/416,838

(22) PCT Filed: Dec. 21, 2018
(86) PCT No.: PCT/EP2018/086735

§ 371 Date: Jun. 21, 2021

(51) Int. Cl. A62C 3/02; B64C 39/02; B64D 1/18; B64D 27/24

(52) U.S. Cl. CPC A62C 3/0242; B64C 39/024; A62C 27/00; B64D 27/24; B64D 1/18

(57) ABSTRACT

A firefighting apparatus comprising at least one Unmanned Aerial Vehicle (UAV) 11, the at least one UAV 11 comprising an engagement mechanism 96, 61 for releasable engagement with a container 22 containing a fire suppressant medium. The apparatus further having a cannon 92 for releasing or directing the fire suppressant medium from the container 22 and a ground support base 10 configured to carry a plurality of containers. A controller in operable communication with the at least one UAV 11, the controller configured to receive and/or or calculate information in relation to the levels of fire suppressant medium in the container 22 carried by the at least one UAV 11 and to direct the at least one UAV 11 to return to the ground support base 10 to replenish, or deposit and replace, the container should the contents of the receptacle be depleted beyond a threshold value.

### FIELD OF THE INVENTION

This invention relates to an apparatus and method for firefighting, and in particular to an apparatus and method utilising Unmanned Aerial Vehicles (UAVs).

### BACKGROUND OF THE INVENTION

Aerial firefighting employing helicopters and fixed wing aircraft has been used to counter wildland fires which occur in forests and other remote areas, but very little progress has been made involving aerial fire fighting in conjunction with high-rise buildings, which present inherent challenges that cannot be addressed by traditional rotorcraft, and where the use of UAVs is unheard-of, other than for surveying the site and providing intelligence.

Traditional aerial firefighting has been extensively used in wildfire suppression, employing helicopters and fixed wing tanker airplanes. The drawback is that these aircraft can only carry a limited amount of a fire suppressant medium, which is typically water, while also lacking a way of delivering it accurately and steadily in order to suppress the fire propagation. Helicopters are usually outfitted with tanks or the like, which may be refilled from nearby lakes and rivers or portable supplies and then released over the fire in a concentrated column. Fixed wing aircraft are fitted with internal tanks which release the extinguishing material in a bomber fashion, flying back to the airbase in order to refill their tanks. Currently the role of UAVs in aerial firefighting is mainly limited to the gathering of intelligence.

Modern high-rise fires present a set of difficulties which cannot be met by the techniques of traditional aerial firefighting, as firebombing would be of little use and dangerous to the firefighters below, while rotorcraft would become difficult to manoeuvre and unstable when faced with the intense recoil force of the water jet, not to mention the unpredictable atmospheric conditions surrounding fire zones. A skyscraper or high-rise fire is one of the most demanding types of structural fires, requiring the concerted action of multiple authorities and resources in order to prevent a catastrophe. The fire may spread both internally and on the outside of the building, becoming difficult to contain and growing to devastating proportions. If not handled successfully, the fire may engulf the entire height of the building.

While the internal spread of fire can be countered with general firefighting techniques, or even automatic fire suppression such as sprinkler systems (provided they are in good condition), counteracting the external fire spread becomes increasingly difficult once a certain height is exceeded. Typically, a hose can only expel water vertically over a range of 20 to 30 meters by itself, depending on pressure, and even when extended with the aid of a ladder, it is not generally efficient over more than 30 meters. The highest turntable ladder in the world currently extends up to 112 meters, being destined mainly for rescue operations.

Although several solutions involving UAVs have been proposed previously, they have never been implemented due to the various constraints of a high-rise fire-fighting intervention, for which they are apparently unsuitable, as they currently stand. Such a solution is disclosed in patent application no. WO2014080385A2, which claims an arrangement of several UAVs which can carry a hose up to a certain height while tethered to a fire truck hydrant. Another similar solution, seemingly geared towards wildland fire suppression, is described in patent application no. US20130134254A1, claiming a UAV that is “stabilized in the air via a system of gyroscopes with a series of electric motors capable of moving to counteract the opposing recoil force exhibited as water escapes the nozzle of the tether”. Here the tether is also used to power the motors during flight. Such solutions can not handle the significant heights involved in high-rise firefighting, seeing as how the weight of a charged 5-inch hose of a length of only 30 m is approximately 428 kg. Modern high-rise buildings currently exceed 800 m and are expected to reach heights of up to a kilometre in the near future. Moreover, the above disclosures imply that the UAVs will be carrying/tethered to a hose, which would greatly restrict the movement of the UAVs around the target building.

Patent application no. CN107472536A and no. KR20170079150A both propose the use of fire extinguishing bombs or missiles deployed by battery powered UAVs. These may also be able to carry supplies such as fire extinguishers or breathing masks. It is known that high-rise fires typically require a very large effort to extinguish or contain past a certain threshold, which is unattainable through the limited means of the disclosures of these applications. High-rise fire-fighting requires an elaborate aerial intervention, capable of deploying a sufficient amount of extinguishing agent in a steady manner during a significant time period. Furthermore, difficulties such as the overall mission safety, the ability to navigate urban areas and the response time, all place additional constraints on the technology.

It is desirable to provide a firefighting apparatus which is capable of supplying a sufficient volume of fire suppressant medium to a fire, for a sufficient duration, in order to suppress or extinguish the fire, whilst exhibiting flexible manoeuvrability.

### SUMMARY OF THE INVENTION

According to the invention there is provided a firefighting apparatus comprising at least one Unmanned Aerial Vehicle (UAV), the at least one UAV comprising engagement means for releasable engagement with a receptacle containing a fire suppressant medium; a means for releasing or directing the fire suppressant medium from the receptacle; a ground support base configured to carry a plurality of receptacles; a control means in operable communication with the at least one UAV; wherein the control means is configured to receive and/or calculate information in relation to the levels of fire suppressant medium in the receptacle carried by the at least one UAV and to direct the at least one UAV to return to the ground support base to replenish, or deposit and replace, the receptacle should the contents of the receptacle be depleted beyond a threshold value.

Advantageously, the UAV's may be supplied with sufficient fire suppressant medium to extinguish the fire without the requirement to be tethered to a permanent supply thereof via a hose or other such supply means.

Preferably, the ground support base comprises a transfer system.

Ideally, the transfer system is configured to move receptacles between a first position, wherein the at least one UAV may access and engage with and/or deposit the partially replenished receptacles, and a second position wherein the receptacles are positioned for replenishment.

Preferably, the at least one UAV is powered by a rechargeable electric power source, the ground support base comprising recharging means for recharging the rechargeable electric power source.

Ideally, the control means is configured to receive and/or calculate information in relation to the charge levels of the rechargeable electric power source.

Preferably, the rechargeable electric power source is a power source such as a battery.

Most ideally, the power source is a high capacity battery.

Ideally, the receptacle comprises a compartment for housing the power source.

Preferably, the receptacle comprises a compartment for housing the fire suppressant medium.

Ideally, the means for recharging the rechargeable electric power source comprises a power source charging system.

Preferably, the means for recharging the rechargeable electric power source comprises a generator.

Preferably, the control means is configured to direct the at least one UAV to return to the ground support base to recharge should the charge level be depleted beyond a threshold value.

Ideally, the threshold value is such that sufficient charge remains to travel to the ground support base.

Preferably, the apparatus comprises a plurality of UAV's.

Most preferably, the apparatus comprises a pair of UAV's.

Advantageously, as one UAV returns to the ground support base for replenishment of fire suppressant medium and/or for recharging of the power source, at least one other UAV may continue to attack the fire.

Ideally, the fire is attacked constantly by at least one UAV.

Alternatively, the control of a UAV by the control means between the fire and the ground support base may be dictated by the presence of other UAV's and their present role in the firefighting operation, the control means being configured to calculate the most efficient use of each UAV and direct the plurality of UAV's accordingly.

Ideally, the rechargeable electric power source is housed in or on the receptacle.

Preferably, the rechargeable electric power source is operably connectable to a motor of the at least one UAV when the UAV is in engagement with the receptacle.

Ideally, the motor is an electrical motor.

Ideally, when located on the ground support base, the rechargeable electric power source is engageable with at least one output of the recharging means.

Preferably, the output of the charging means is a charging contact.

Preferably, the engagement between the rechargeable electric power source and the recharging means is sufficient in duration to at least partially charge the rechargeable electric power source.

Alternatively, as the receptacles are moved by the transfer system, the rechargeable electric power source is engageable with a plurality of outputs of the recharging means.

Ideally, the transfer system is configured to move receptacles into at least one charging position, wherein the rechargeable electric power source is in operable engagement with the charging means and charged thereby.

Preferably, the ground support base is configured to refill depleted receptacles deposited by the at least one UAV with fire suppressant medium.

Ideally, the ground support base refills depleted receptacles via an external source of fire suppressant medium in operable connection with the ground support base.

Preferably, the fire suppressant medium is water.

Alternatively, the fire suppressant medium is a fire retardant such as but not limited to sodium bicarbonate, potassium bicarbonate, or monoammonium phosphate.

Ideally, the ground support base refills depleted receptacles via a connection to a fire hydrant, fire hose, or other mains source of water operably connectable to the ground support base.

Preferably, the fire hydrant, fire hose, or other mains source of water is in operable engagement with the receptacles via a releasable connection mechanism.

Ideally, the releasable connection mechanism comprises a valve.

Preferably, the ground support base comprises a pump to aid refilling of depleted receptacles.

Preferably, the ground support base refills depleted receptacles via a reservoir of fire suppressant medium contained thereon.

Ideally, the ground support base comprises an upper level, wherein the receptacles are accessible by the at least one UAV.

Preferably, the ground support base comprises a lower level wherein the receptacles are refilled.

Ideally, the receptacles are movable between the upper and lower levels by the transfer system.

Preferably, the upper and lower levels of the ground support base comprise elongate upper and lower decks having first and second longitudinal ends.

Ideally, the upper deck is locatable directly above the lower deck.

Preferably, the upper and lower decks are of substantially the same in terms of size such that in plan view they exhibit substantially the same footprint.

Ideally, the transfer system comprises a horizontal transfer means configured to transfer receptacles between longitudinal ends of the upper and lower decks.

Preferably, the horizontal transfer means comprise a pair of guideways along which a series of platforms may move on roller bushings.

Preferably, the transfer system further comprises vertical transfer means configured to transfer the receptacles between the upper and lower decks.

Ideally, the vertical transfer means are elevators.

Preferably, the elevators are configured to accommodate one platform.

Ideally, the transfer system transfers the receptacles in a cycle between the upper and lower decks of the ground support base.

Ideally, within the cycle, receptacles deposited on the upper level of the ground support base are transferred towards the first longitudinal end thereof before being transferred to first longitudinal end of the lower level by a first vertical transfer means.

Preferably, the receptacles received by the first longitudinal end of the lower level are further transferred to the second end thereof whereat the receptacles may be transferred to the second end of the upper level by a second vertical transfer means.

Preferably, as the receptacles travel around the cycle, they are positioned in at least one position wherein they may be replenished with fire suppressant material.

Preferably, as the receptacles travel around the cycle, they are positioned in at least one position wherein the rechargeable electric power supply may be recharged by the recharging means.

Alternatively, the ground support base may be devised in any manner in which the receptacles may be moved such that are replenished and/or charged and subsequently moved such that they are engageable with the at least one UAV.

Ideally, the means for releasing or directing the fire suppressant medium from the receptacle is a fire suppressant delivery means.

Ideally, the fire suppressant delivery means comprises a directional control means.

Preferably, the fire suppressant delivery means comprises a pump for delivering the fire suppressant medium from the receptacle to the directional control means.

Ideally, the fire suppressant delivery means comprises ducting or pipework connectable between the receptacle and the directional control means for facilitating travel of fire suppressant therebetween.

Preferably, the directional control means is a nozzle.

Ideally, the nozzle is a movable nozzle such that it may be moved to at least partially control the direction of fire suppressant leaving as it leaves the nozzle.

Preferably, the nozzle is an adjustable nozzle having an outlet of adjustable diameter such that the flow rate of fire suppressant medium may be at least partially dictated by the diameter of the outlet.

Ideally, the nozzle and/or the pump are in operable communication with the control means.

Preferably, the control means comprises a processor and a storage medium, the storage medium having software modules storable thereon which are executable by the processor to control at least the operations in relation to replenishment or replacement of receptacles.

Ideally, the storage medium of the control means has software modules storable thereon which are executable by the processor to control the operations in relation to the recharging of the rechargeable electric power source and/or the directing of fire suppressant medium from the receptacle.

Preferably, the storage medium of the control means has software modules storable thereon which are executable by the processor to control aspects of the planning of firefighting activities, and/or flight operations of the at least one UAV, and/or control of execution of firefighting activities.

Ideally, the at least one UAV comprises a plurality of rotors.

Preferably, the rotors are locatable on rotor arms.

Ideally, the rotor arms are foldable rotor arms such that they may be folded to facilitate transportation of the UAV.

Preferably, the at least one UAV further comprises a Flight Management Unit (FMU) in operable engagement with each rotor and configured to control the thrust levels thereof during standard air manoeuvres.

Ideally, the FMU is in operable communication with thrust level sensors configured to measure the thrust of the rotors.

Preferably, the FMU monitors and adjusts the thrust of each rotor such that correct attitude of the aircraft is maintained.

Ideally, the FMU is configured to carry out calculations related to navigation.

Preferably, the FMU is in operable engagement with a means for detecting forces or changes in attitude experienced by the UAV as a result of releasing or directing fire suppressant therefrom.

Ideally, the FMU is configured to counter such forces or changes in attitude by adjustment of the thrusts of one or more of the rotors in response to an output from the means for detecting forces or changes in attitude.

Preferably, the FMU comprises a processor and a storage medium having software modules storable thereon, the software modules being executable by the processor.

Ideally, the FMU and the control means are in operable communication.

Ideally, the FMU and the control means are in wireless operable communication.

Preferably, the control means is configured to receive information in relation to a variety of flight parameters of the at least one UAV from a sensor array in operable engagement with the FMU.

Ideally, the information in relation to a variety of flight parameters includes but is not limited to location, velocity, attitude, and/or altitude.

Preferably, the sensor array may incorporate several sensors such as but not limited to accelerometers, tilt sensors and/or gyroscopes.

Preferably, the control means is configured to receive data in relation to the fire.

Ideally, the data in relation to the fire includes but is not limited to intensity, location, and/or imagery in two dimensions or three dimensions of the fire.

Preferably, the information in relation to the fire can be manually input by a user or may be obtained from fire information sensors and/or imaging devices locatable on the at least one UAV.

Ideally, the fire information sensors may comprise but are not limited to thermal sensors, gas sensors and/or cameras.

Ideally, the fire information sensors and/or imaging devices are in operable communication with the control means via the FMU or otherwise.

Ideally, the control means is configured to receive information in relation to the ground support base from base sensors locatable on the ground support base.

Preferably, the data in relation to the ground support base comprises but is not limited to the location thereof, the location of each receptacle thereon, the replenishment status of each receptacle, the and/or charge status of each rechargeable electric power source of each receptacle.

Ideally, the base sensors are in operable communication with the control means.

Preferably, a communication interface facilitates operable communication between the FMU, control means, the sensor array, the fire information sensors and/or imaging devices, and/or the base sensors.

Preferably, the control means has software executable on the storage medium thereof, the software being executable by the processor and configured to direct the at least one UAV to conduct the firefighting process in the most efficient manner given information/data received from the FMU, the sensor array, the fire information sensors and/or imaging devices, and/or the base sensors.

Alternatively, at least a part of the control of the UAV's is carried out by a human operative via a control interface in operable communication with the control means.

Ideally, the control means is a ground control station.

Preferably, the control means is integral of the ground support base.

Preferably, the receptacles are containers.

Ideally, the ground support base is a mobile ground support base which is utilised to transport the receptacles and/or the at least one UAV to the site of a fire.

Preferably, the ground support base is a ground support vehicle.

Preferably, the ground support base comprises stabilisation means deployable at the site of a fire.

Ideally, the firefighting apparatus is configured for fighting of fires located in high rise structures.

According to a second aspect of the invention there is provided an Unmanned Aerial Vehicle (UAV) for use in a firefighting apparatus, the UAV comprising: a Plurality of rotors; engagement means for releasable engagement with a receptacle containing a fire suppressant medium; a means for releasing or directing the fire suppressant medium from the receptacle; a Flight Management Unit (FMU) configured to control the thrust levels of the plurality of rotors during at least standard air manoeuvres; the UAV being in operable communication with a control means; wherein the control means is configured to receive information in relation to the levels of fire suppressant medium in the receptacle carried by the at least one UAV and to direct the at least one UAV to return to a ground support base to replenish, or deposit and replace, the receptacle should the contents of the receptacle be depleted beyond a threshold value.

According to a third aspect of the invention there is provided ground support base for use in a firefighting apparatus employing at least one Unmanned Aerial Vehicle (UAV), the ground support base being configured to carry a plurality of receptacles for containing fire suppressant medium and comprising a transfer system configured to move receptacles between a first position, wherein the at least one UAV may access and engage with at partially replenished receptacles, and a second position wherein the receptacles are positioned for replenishment.

According to a fourth aspect of the invention there is provided a control means for a fire fighting apparatus employing at least one Unmanned Aerial Vehicle (UAV), the UAV being configured for releasable engagement with a receptacle containing a fire suppressant medium, the control means comprising a processor and a storage medium, the storage medium having software modules storable thereon which are executable by the processor to control at least the operations in relation to replenishment or replacement of the receptacle.

According to a fifth aspect of the invention there is provided a method of firefighting comprising the steps of: delivering one or more firefighting Unmanned Aerial Vehicles (UAVs) and one or more receptacles containing fire suppressant to the site of the fire; the one or more UAVs engaging with a receptacle containing a fire suppressant medium and carrying the engaged receptacle to a location of the fire before depositing the fire suppressant medium in a manner which acts to at least partially extinguish or suppress the fire; a control means receiving information in relation to the levels of fire suppressant medium in the receptacle carried by the at least one UAV and to directing the at least one UAV to return to a ground support base to replenish, or deposit and replace the receptacle should the contents of the receptacle be depleted beyond a threshold value.

Ideally, the method further comprising the ground support base replenishing the depleted receptacles once deposited thereon by the UAV's.

Preferably, the method further comprising the step of the ground support base positioning the replenished receptacles for engagement with the one or more UAV's.

Ideally, the method further comprising the step of the UAV's returning to the ground support base to deposit a depleted receptacle and engage with a replenished receptacle until the fire is satisfactorily extinguished or suppressed.

According to a sixth aspect of the invention there is provided a computer readable medium comprising non-transitory instructions which, when executed, cause a processor to carry out a method as described herein.

### BRIEF DESCRIPTION OF THE DRAWINGS

FIG. 1 depicts the preferred layout of a firefighting apparatus, including Unmanned Aerial Vehicles (UAVs) seated atop a ground support vehicle for transportation and receptacles thereon;

FIG. 2A presents the transfer system of the ground support vehicle as seen from a first side;

FIG. 2B presents the transfer system of the ground support vehicle, as seen from a second side;

FIG. 2C presents an output of a charging means of the ground control vehicle;

FIG. 2D shows a firehose and associated releasable connection mechanism utilised to refill the receptacles;

FIG. 2E presents the platforms of the ground support vehicle along which the receptacles are transported as part of the transfer system;

FIG. 2F is a detail view of the elevators of the transfer system for moving the receptacles from the lower platform to the upper platform;

FIG. 3A depicts a receptacle for use with the apparatus showing a valve thereof;

FIG. 3B depicts view of the receptacle of FIG. 3A from the opposing end;

FIG. 3C is a sectional view of the receptacle showing a compartment for housing the power source and the compartment for housing fire suppressant medium;

FIG. 4 is a circuit diagram of a power source charging system;

FIG. 5A is a perspective top view of a UAV;

FIG. 5B is a perspective underside view of a UAV;

FIG. 6 is a schematic diagram of the Flight Management Unit (FMU) involved in controlling the UAV;

FIG. 7 is a process flow chart outlining the interaction between the UAVs and ground support vehicle during the aerial firefighting operation;

FIG. 8 is a schematic representation of a UAV during a fire suppressant discharging procedure;

FIG. 9 shows a command hierarchy of the firefighting apparatus;

FIG. 10 is a flowchart depicting the operation of a ground control system of the apparatus;

FIG. 11 is a schematic diagram of the components of the ground control system as related to the firefighting apparatus as a whole;

FIG. 12 is a 3D model of an intervention area; and

FIG. 13 is a simplified 2D view showing the flight paths of the UAV's.

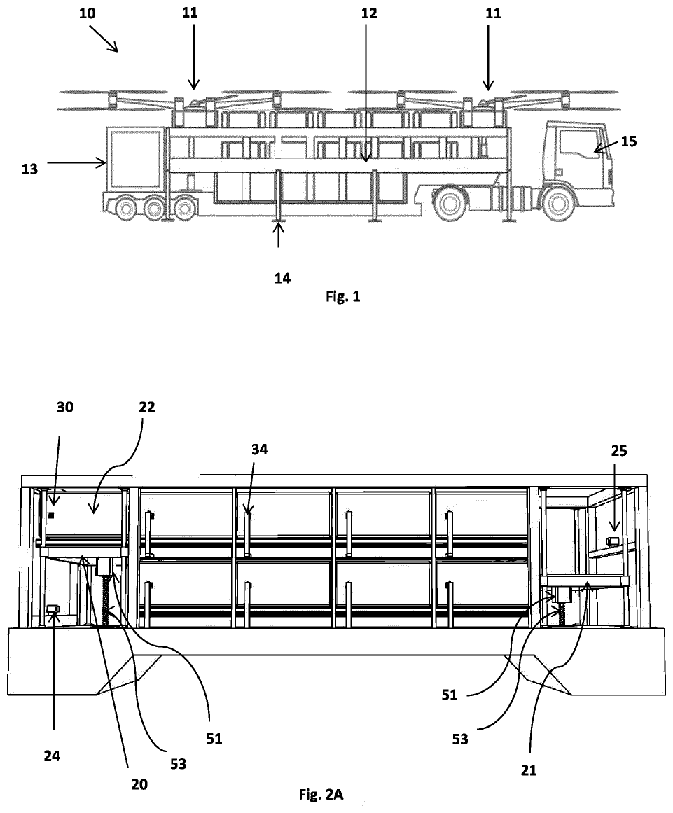

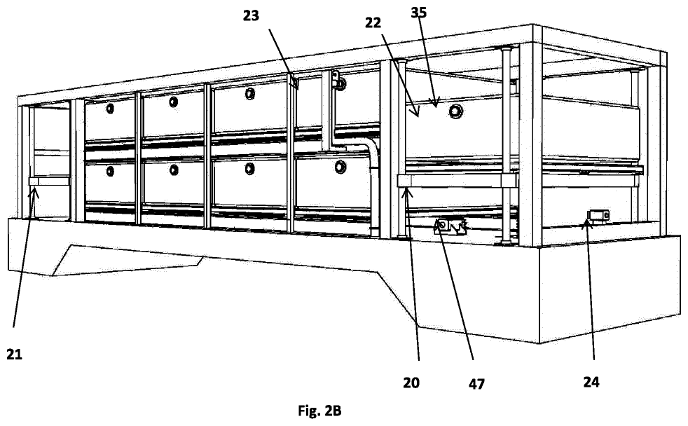

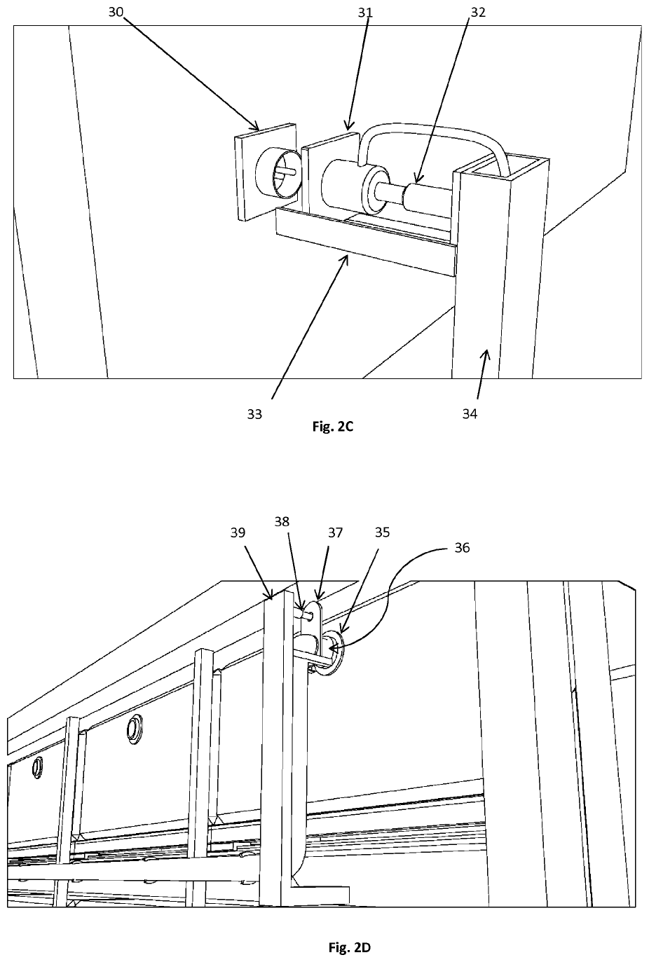

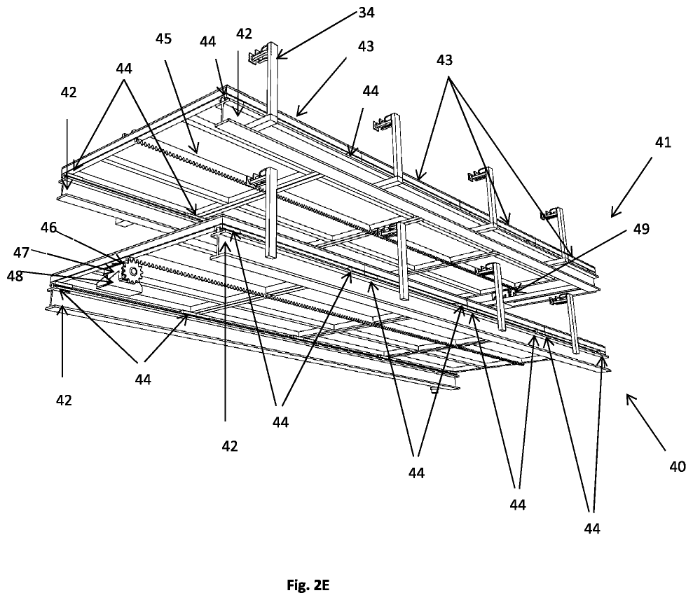

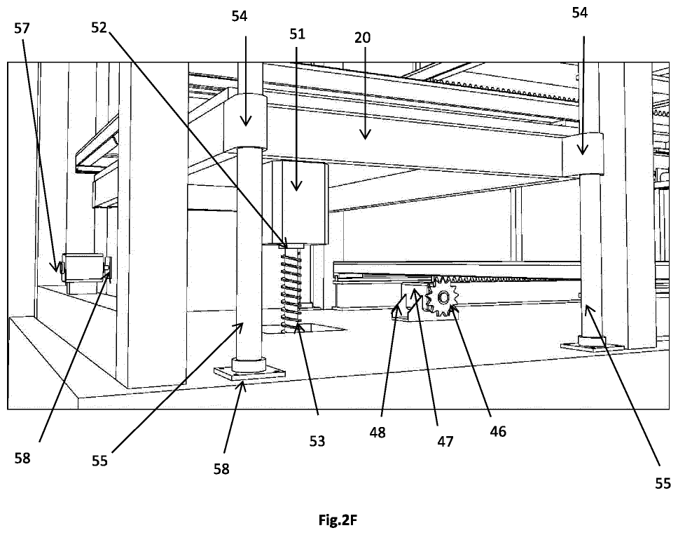

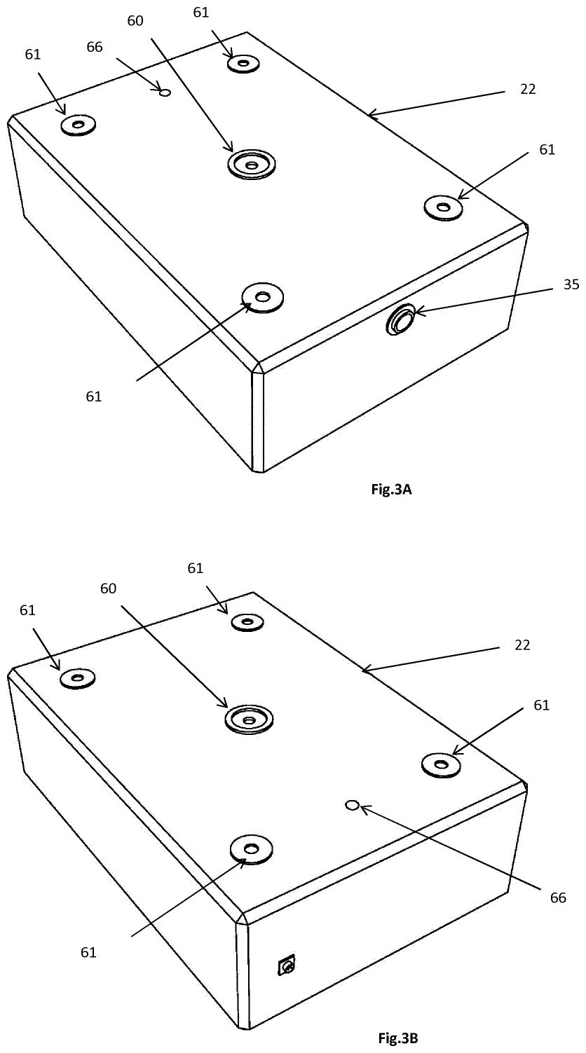

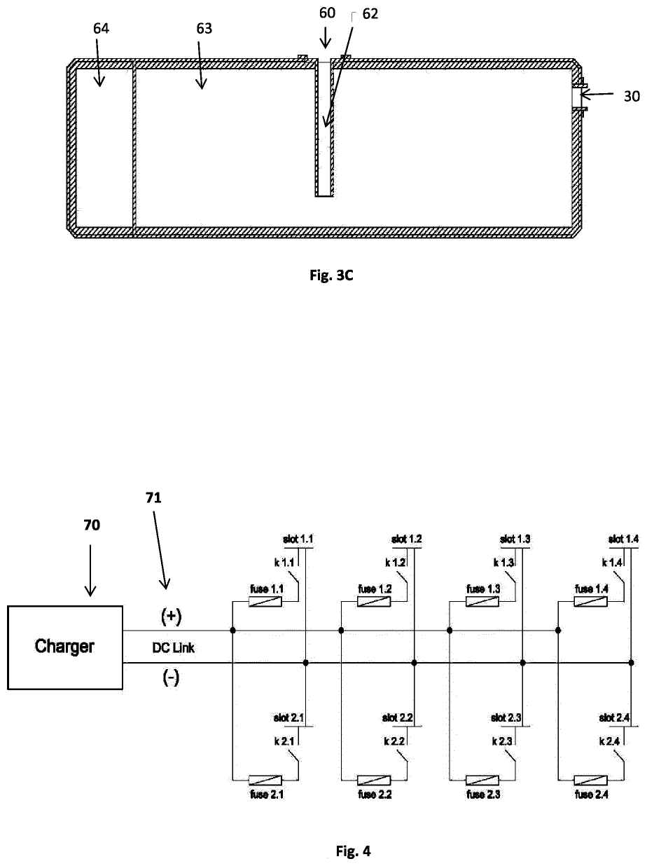

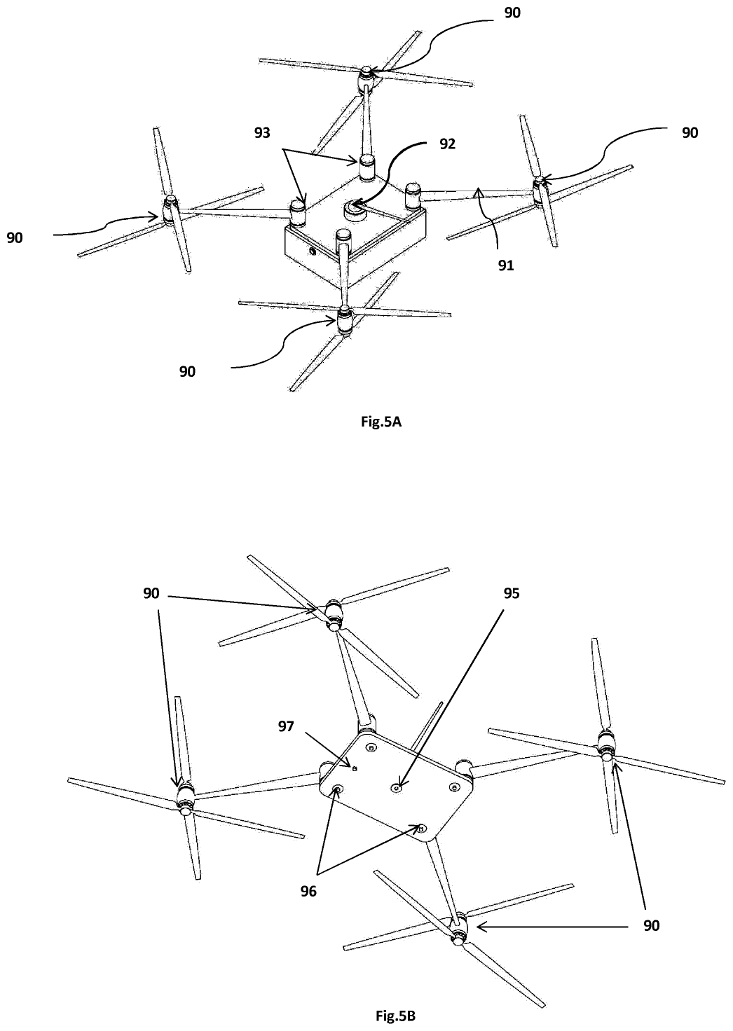

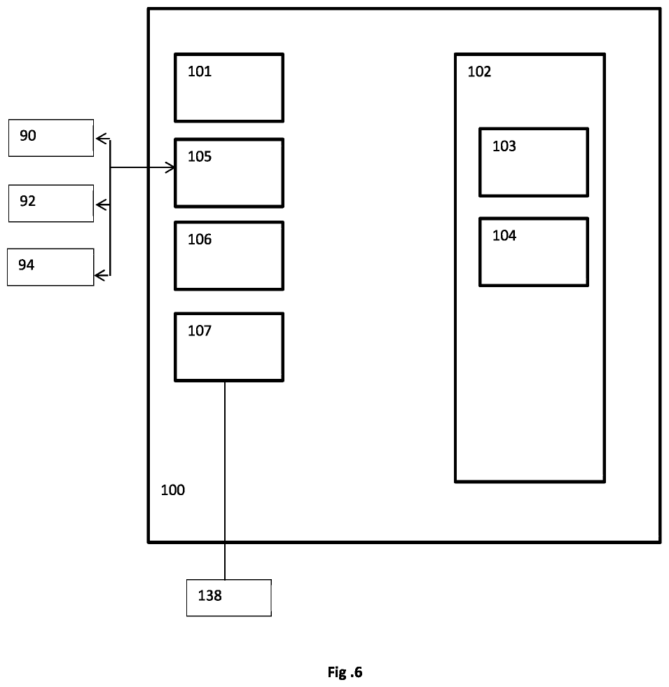

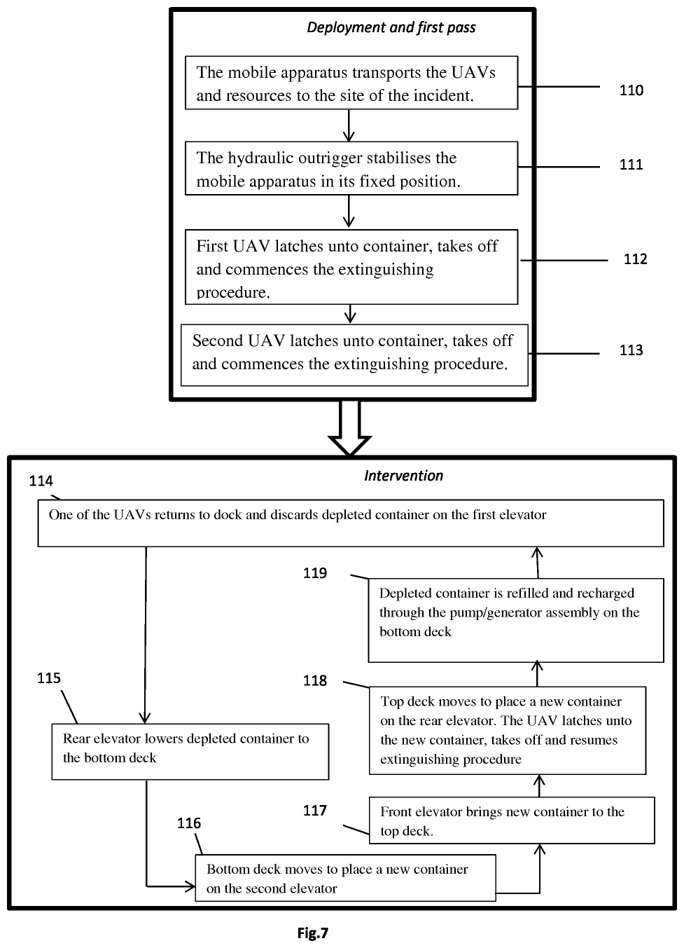

### DETAILED DESCRIPTION OF THE DRAWINGS

The present teaching will now be described with reference to an exemplary firefighting apparatus and method. It will be understood that the exemplary firefighting apparatus and method is provided to assist in an understanding of the present teaching and are not to be construed as limiting in any fashion. Furthermore, elements or components that are described with reference to any one Figure may be interchanged with those of other Figures or other equivalent elements without departing from the spirit of the present teaching.

Referring now to the Figures there is illustrated one embodiment of a firefighting apparatus comprising at least one Unmanned Aerial Vehicle (UAV) 11, the at least one UAV 11 comprising nipple screws 96 for releasable engagement with a container 22 containing water via clamping modules 61 thereof. The apparatus also comprises a ground support vehicle 10 which is a custom vehicle outfitted with special assemblies, designed to transport all the resources required for a fire intervention and to serve as a ground base for the UAVs 11. After initially being carried to the scene of the incident by the ground support vehicle 10, the UAVs 11 may take off and commence the extinguishing operation, while periodically returning to the ground support vehicle 10 in order to resupply during the course of the intervention. Resupplying may be accomplished with the aid of a transfer system 12 and a pump/generator assembly 13.

The transfer system 12 comprises a steel frame able to support two parallel levels, decks or storeys: a lower deck 40 and an upper deck 41. Each deck 40, 41 consist of a pair of guideways 42, whereupon several platforms 43 may be attached by way of roller bushings 44 in order to be directed along a horizontal axis. A rack segment 45 may be attached across the bottom surface of each platform 43, thus allowing all the constituent platforms on one deck 40, 41 to form a long continuous rack 45. The rack 45 may then be driven by a pinion 46, 49 which may be further actioned by a servomotor 47, affixed to the transfer system 12 by way of steel mount 48. A pinion 46 and servomotor 48 may be positioned at one end of each deck 40, 41 between the deck 40, 41 proper and an elevator 20, 21, thus enabling the platforms 43 to move linearly in one direction along a horizontal axis.

The transfer system 12 further comprises two elevators 20, 21: the rear elevator 20 and the front elevator 21. Each elevator 20, 21 comprises a ball screw actuator comprising an electric motor 51 which may drive a ball nut 52 to rotate around a threaded shaft 53. The threaded shaft 53 is fixed to the chassis or frame of the transfer system 12. Each elevator 20, 21 may further comprise four bushings 54 in order that it may glide along four guideways 55 which may be permanently affixed to the frame of the transfer system 12 by way of four fixed flanges 56, and which may support the movement of the elevators 20, 21 along a vertical axis. Behind each elevator 20, 21 a hydraulic cylinder 24, 25 may be installed for the purpose of nudging the platforms 43 into engagement with the pinion 46 and adjacent rack segment 45 respectively. Each hydraulic cylinder 24, 25 may include a mount 57 affixed to the frame of the transfer system 12, and a piston 58 in operable engagement with the platforms 43 to be transported by the elevators 20, 21.

In the embodiment shown in the drawings, the platforms 43 on the lower deck 40 may be driven by the bottom pinion 46 along the bottom pair of guideways 42, with the purpose of placing a platform 43 on the front elevator 21, which may then ascend thereon. Upon reaching the upper deck 41, the hydraulic cylinder 25 may push the platform 43 to bring its rack segment 45 into alignment with the adjacent platform's 43 rack segment 45. Likewise, the platforms 43 on the top deck 41 may then be driven by the top pinion 49 along the top pair of guideways 42, with the purpose of placing a new platform 43 on the rear elevator 20, which may then descend thereon. Upon reaching the lower deck 40, the hydraulic cylinder 24 may push the platform 43 to bring its rack segment 45 into alignment with the adjacent platform's 43 rack segment 45, thus completing one transfer cycle. Thus, the two decks 40, 41 represent a single circuit rotating in a counter clock-wise direction.

Each platform 43 may support a number of containers 22. Each container 22 may include two compartments: the water tank compartment 63 and the battery pack compartment 64. Each container 22 may further be outfitted with a power socket 30 for the purpose of recharging a battery pack thereof, as well as a valve coupling 35 for the purpose of refilling the water tank compartment 63. The power socket 30 is a DC power socket 30. The DC power socket 30 and valve coupling 35 may be located on two opposite lateral sides of the container 22. The frame of the transfer system 12 is designed so as to allow the battery pack stored within the battery pack compartment 64 to be recharged via a DC link 71. A generator 70 is located within the pump/generator assembly 13, located at the rear side of the ground support vehicle 10. The generator 70 is be able to supply power through eight power plugs 31, which may be supported by metal profiles 34. The number of power plugs is variable depending on the scale of the apparatus. The metal profiles 34 are attached to the frame of the transfer system 12. The power plugs 31 are driven along a guideway 33 by a pneumatic cylinder 32, so as to engage with the power sockets 30 to recharge the battery packs stored within the battery pack compartments 64.

The frame of the transfer system 12 is designed so as to allow the water tank compartment 63 of a container 22 to be refilled through a water pump located within the pump/generator assembly 13. The water pump is connected to a standard fire hydrant in order to ensure a constant water supply, which it may then direct through a firehose 36; the firehose 36 is attached to the frame of the transfer system 12 and supported by a metal profile 39. The firehose 36 is connected to the metal profile 39 with a steel joint 37, which may be actioned by a small pneumatic cylinder 38 in order to engage the firehose 36 with the lateral valve coupling 35 located on the container 22 which has reached the designated spot 23.

A freestanding vertical pipe 62 is located within the container 22; the vertical pipe 62 is permanently attached to the upper valve coupling 60, located on the top side of the container 22. The upper valve coupling 60 is engageable with an on-board water pump 94, located inside the UAV 11. The vertical pipe 62 may then act as an extension for the UAV's 11 on-board water pump 94. The container 22 also comprises four zero-point clamping modules 61, located in each corner of the top surface of the container 22. The clamping modules 61 allow the container 22 to be picked up by four corresponding engagement nipple screws 96 located on each corner of the bottom surface of the UAV 11. The clamping modules 61 are opened hydraulically or pneumatically. The clamping modules 61 may also be locked through spring force. It should be noted that this is only one example of an attachment arrangement suitable for deployment between the container 22 and the UAV 11. Any suitable quick release attachment may be utilised without departing from the scope of the invention. Additionally the container 22 includes a power plug 66, located on the top surface of the container 22, above the battery pack compartment 64, which is engageable with a power socket 97 located on the bottom surface of the UAV 11.

A hydraulic outrigger 14 is employed in order to stabilize the ground support vehicle 10 during the intervention. It may achieve this, for example, through the use of a hydraulic pump driven by an electric motor; hydraulic electric valves and hydraulic pistons. The ground support vehicle 10 comprises a control unit 15 destined to manipulate the position of the containers and the elevators, issuing commands for all the corresponding servomotors. The control unit features an I/O (input/output) programmable logic controller (PLC) configured to control the various parts (sensors, electro valves) of the transfer system 12. The control unit 15 may include a type of human-machine interface (HMI), consisting of an input panel and real time graphical interface of the equipment, which may be operated by a crew member of the ground support vehicle 10. The control unit 15 may alternatively be designed to receive and transmit data to the autonomous ground control station 130, in which case it may include a wired communication interface, Bluetooth, cellular transceiver, a satellite communication transmitter/receiver, an optical port and/or any other such interfaces for wired or wireless connection of the control unit 15 to an autonomous ground control station 130.

In the embodiment as shown in the drawings, the UAV 11 features eight rotors arranged coaxially in groups of two, which are powered by a high capacity battery pack, stored within the battery pack compartment 64. The power socket 97 located on the bottom side of the UAV 11 may be engageable with the power plug 66 situated on the top surface of the container 22, above the battery pack compartment 64. The UAV 11 is outfitted with a water cannon 92; the water cannon 92 expels a high-pressure jet with the aid of an on-board water pump 94 which is engageable with the upper valve coupling 60 located on the top side of the container 22.

Several sensors, such as thermal sensors, gas sensors and cameras, may be incorporated inside a sensor array of the UAV and may collect the data which may be transmitted via wireless network to the ground control station 130. In order to facilitate transportation in urban environments, the two UAVs 11 are equipped with four foldable rotor arms 91, which may allow them to become compact during transit. The rotors 90 are attached to the foldable arms 91. The rotor arms 91 are connected to the UAV 11 through a hinge 93; the hinge 93 allowing the rotor arms 91 to collapse during transportation.

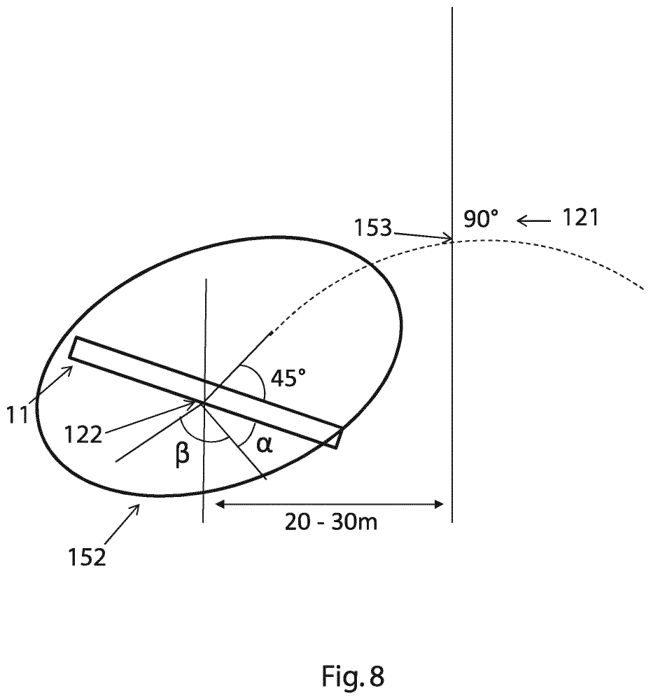

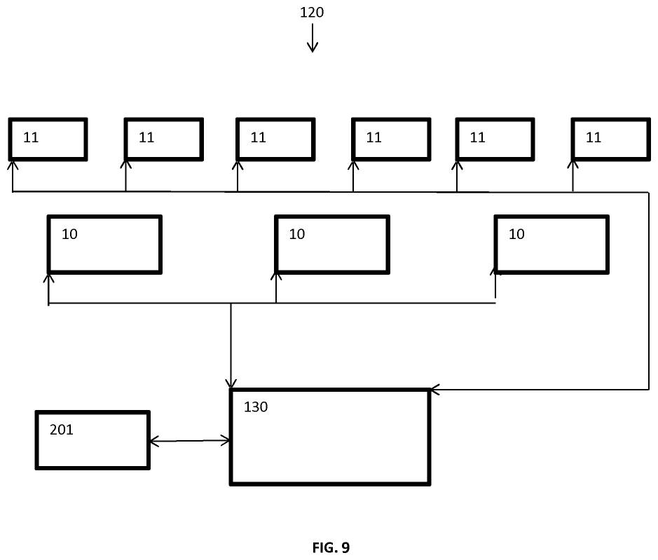

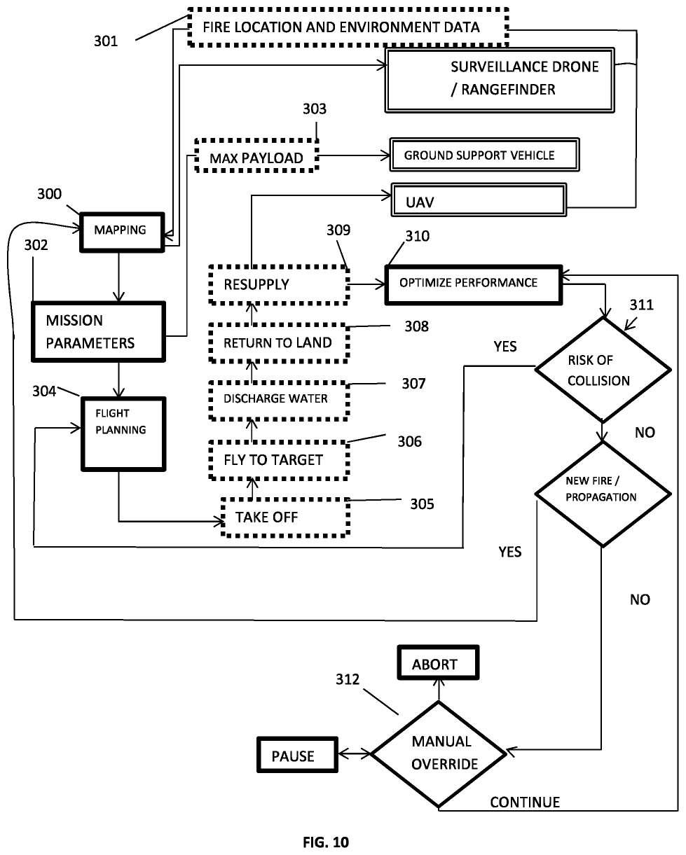

A flight management unit (FMU) 100 controls the UAV 11 and performs tasks associated with steering, navigation, communication and thrust control. The FMU 100 comprises a processor 101 and a memory module 102; the memory modules 102 store the software 103 executable by the processor 101. One or more software modules 103 are encoded in the memory module 102. The software modules 103 comprise one or more software programs or applications having computer program code, or a set of instructions configured to be executed by the processor 101. Such computer program code or instructions for carrying out operations for aspects of the systems and methods disclosed herein may be written in any combination of one or more programming languages. The software modules 103 may include applications pertaining to autonomous flight stabilization through the use of gyroscopes, accelerometers and their associated algorithms, as will be understood by those of ordinary skill in the art. A water cannon control module 104 is included amongst the software modules 103, which includes instructions for controlling the aim of the water cannon during a discharging procedure. As shown in FIG. 8, the water cannon control module 104 ensures a perpendicular deployment 121 of the water jet on the vertical plane of the targeted fire hotspot 153. The water cannon control module 104 also compensates for the recoil exerted on the UAV 11 during the high-pressure discharge. The program code of the software modules 103 and one or more computer readable storage devices, such as the memory module 102, form a computer program product that may be manufactured and/or distributed in accordance with the present disclosure, as is known to those of skill in the art.

The communication interface 105 is operatively connected to the processor 101 and may be any interface that enables communication between the FMU 100 and external devices, machines and/or elements including the cannon 92, pump 94, and rotors 90. The communication interface 105 may be configured to transmit and/or receive data. For example, the communication interface 105 may include but is not limited to a wired communication interface, Bluetooth, cellular transceiver, a satellite communication transmitter/receiver, an optical port and/or any other such interfaces for wired or wireless connection of the FMU 100 to any required external devices. The navigation module 106 may comprise various accelerometers and gyroscopes which assist with flight stabilization and may be handled by specific applications within the software modules 103.

A transceiver 107, is also connected to the processor 101 and may be any interface that enables communication between the FMU 100 and a control and communication interface 138 installed on the ground control station 130. The transceiver 107 may be configured to transmit via wireless network the flight parameters as recorded by the navigation module 106, as well as the sensor array feeds (camera, thermal imaging, gas sensors). It may also receive data from the control and communication interface 138 in the form of flight commands involved in steering the aircraft, such as thrust, pitch and yaw; these commands may be handled by a UAV navigation module 134 installed on the ground control station 130. The transceiver 107 may also allow the water cannon 92 to be controlled during the discharging procedure by specific software contained within the ground control station 130. The operation of the FMU and the implementation of the various elements and components described above will be understood by those skilled in the art as being subject to change without departing from the original vision of the present disclosure.

The ground control station 130, hereafter referred to as the GCS 130 is used to control the UAVs 11, the ground support vehicle 10 and additional surveillance drones 201 during the firefighting procedure. The GCS 130 centralises and manages the pooled resources of multiple firefighting systems involved in a joint operation 120. The GCS, along with its crew, may be transported by a separate mobile vehicle, which is deployed alongside the ground support vehicle 10 at the site of the intervention. The GCS 130 personnel may oversee the intervention and assist the system with specific global information 300 and decision making, such as: locating fire hotspots 300, overriding specific parameters as deemed fit by the qualified personnel, pausing or aborting the mission 309. The GCS 130 comprises a processor 139 and a memory module 137; the memory module 137 stores the software modules 131, 132, 133, 144 employed by the processor 139. The software modules 131, 132, 133, 144 may comprise one or more software programs or applications having computer program code, or a set of instructions configured to be executed by the processor 139. Such computer program code or instructions for carrying out operations for aspects of the systems and methods disclosed herein may be written in any combination of one or more programming languages, as will be understood by those of ordinary skill in the art. The software modules may include a 3D mapping application 131; this application may extrapolate a discretized 3D model of the environment based on 2D digital maps and satellite imagery. The software modules may further include a flight path planning application 132; this application may plot waypoints along the discretized units obtained by the 3D mapping application 131. A resource management application 133 may also be included amongst the software modules; this application may allow the real time calculation of dynamic mission parameters, based on factors such as: the distance between the ground support vehicles 10 and the targeted fire hot spots 153, the exterior temperature, the wind speed and the wind direction, which may be deduced from discrepancies between planned routes and actual location, and the likelihood of a collision, etc. The dynamic mission parameters calculated by the resource management application 133 may include: the maximum payload, the maximum discharge area 152 and the maximum deviation area 151. A UAV navigation application 134 may further be included within the GCS 130; this application issues commands to the FMU 100 installed on the UAV 11, pertaining to different flight modes or missions, such as: take-off, follow waypoints, discharge procedure, landing; the commands may be issued through a communication interface installed on the GCS 130. The UAV navigation application 134 may employ a real time locating system 136 consisting of at least four anchors or beacons 136, connected to the GCS 130, and a specific tag located on each UAV 11. The real time locating system 136 may allow the GCS 130 to accurately identify the position of the UAVs 11 and ensure a precise navigation within the 3D model. The UAV navigation application 134 also issues commands to the surveillance drones 201 such as: take-off, follow waypoints, reconnaissance procedure, stand-by, etc.

A control and communication interface 138 is installed on the GCS 130. The control and communication interface 138 may be operatively connected to the processor 139 and may be any interface that enables communication between the GCS 130 and external devices, machines and/or elements including the FMU 100, the ground support vehicle 10 and the surveillance drones 201. The control and communication interface 138 is configured to transmit and/or receive data from the aforementioned units. For example, the control and communication interface 138 may include but is not limited to a wired communication interface, Bluetooth, cellular transceiver, a satellite communication transmitter/receiver, an optical port and/or any other such interfaces for wired or wireless connection of the GCS 130 to any required external devices. The control and communication interface 138 may also send data to the FMU 100 installed on the UAVs 11 and the surveillance drones 201 in the form of flight commands such as steering, thrust, pitch and yaw. The control and communication interface 138 may also receive data from the FMU 100 installed on the UAVs 11 and surveillance drone 201 in the form of sensor feeds (for example camera, thermal imaging feeds). The control and communication interface 138 also sends data to the ground support vehicle 10 in the form of payload adjustments, servomotor, sensor and electro valve commands. The control and communication interface 138 may also receive data from the ground support vehicle 10 in the form of container availability, malfunctions, etc.

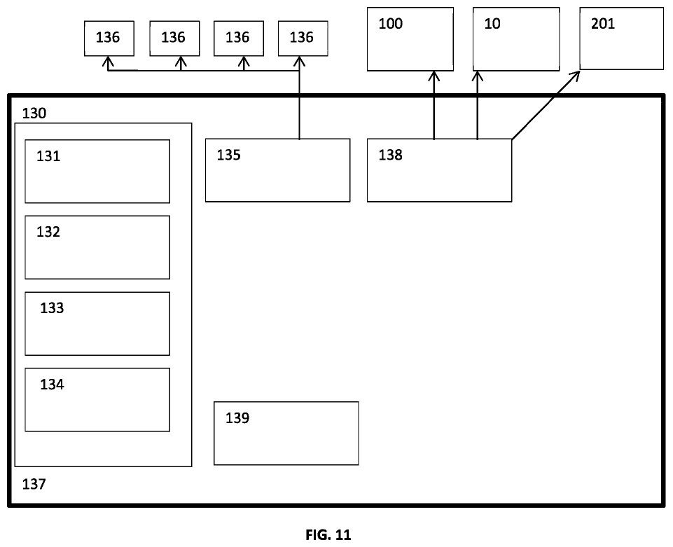

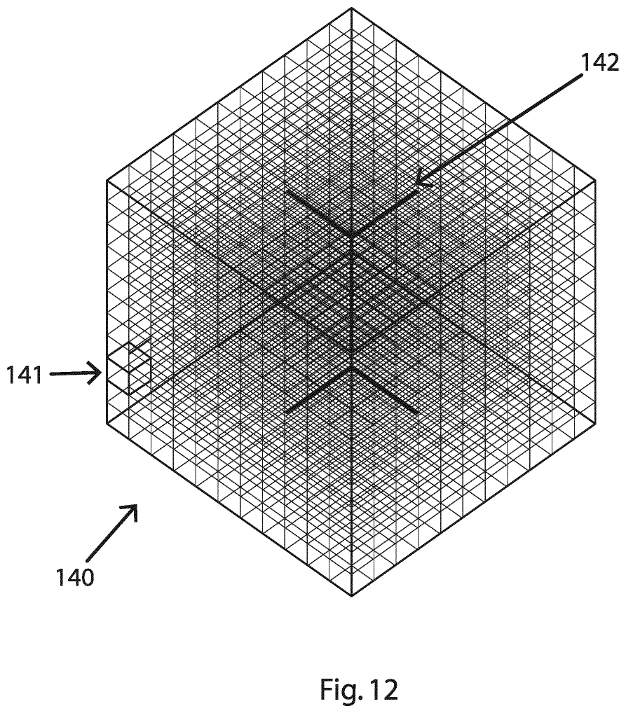

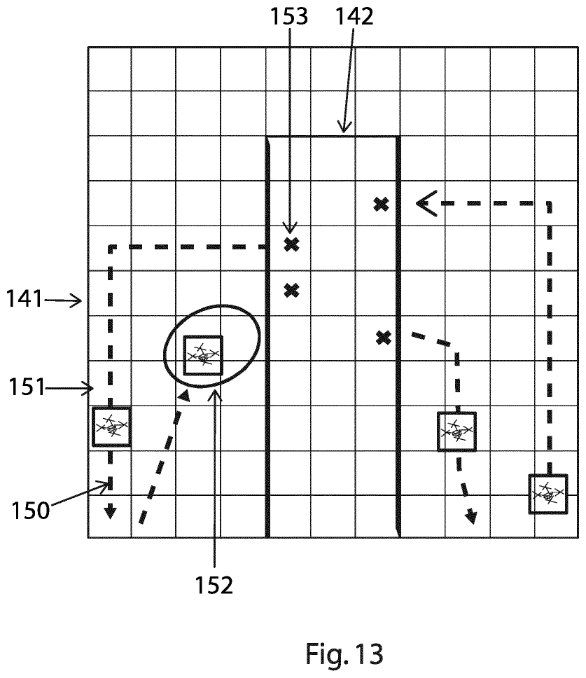

The process or method as employed by the apparatus is shown in FIG. 11. Upon arrival at the scene of the incident, the GCS 130 may first seek to establish a perimeter for the intervention 300. The 3D mapping application 131 may be used to extrapolate a 3D model of the environment from 2D digital maps and satellite imagery. The 3D mapping application 131 may initially determine the size of a virtual cube 140 encompassing the affected area 142 and its immediate surroundings, as best seen in FIG. 13. The geographic coordinates of the cube will be communicated to the relevant authorities and become a restricted airspace for the duration of the intervention 300. The cube may then be discretized into grids of identical cells 141 with a specific resolution (e.g. 1 m³), to be chosen by the GCS personnel. All potential obstacles contained within the perimeter 140 may then be marked on the 3D model. The location of the fire hotspots or targets 153 may be acquired 301 through the use of a surveillance drone 201 or a laser rangefinder operated by qualified GCS 130 personnel. Once the targets 153 are established, the GCS 130 may determine the initial parameters of the mission 301.

The GCS 130 may establish the initial parameters of the mission by taking into account variables which could affect the performance of the UAV 11 during the mission, such as: the distance between the ground support vehicle 10 and the targeted fire hot spots 153, the exterior temperature, the wind speed and the wind direction. The data required to calculate the mission parameters will initially be obtained 301 by the surveillance drones 201, and subsequently refined through sensor fusion with the UAVs 11. The maximum payload to be handled by the UAVs may be one such parameter 303 established by the GCS during the preliminary stage. These parameters may be subject to change throughout the mission, as the resource manager 133 of the GCS may seek to optimise 310 the performance of the UAVs or adjust for unforeseen changes in the resource pool, fire propagation or flight conditions. The GCS 130 may then enter the flight planning stage 304, generating distinct flight paths 150 for all the UAVs 11 involved in the mission, taking into account the aforementioned parameters. A flight path may be conceived as a list of numerical waypoints throughout a series of cubes 141 of known addresses (length, width and height) within the main cube 140 established on the base of the perimeter. Several such lists may be determined according to the different flight modes expected from the UAVs: a list describing the path 306 from the ground support vehicle to the target 153; a list describing the area of delivery 307 (the UAV may hover within a predetermined area while discharging water towards its target; this area, dubbed the “maximum discharge area” 152 may be conceived as an ellipsoid oriented towards the target, which will allow the UAV to move while discharging water in order to obtain a correct angle of attack and to withstand the recoil force through specific manoeuvres); a list describing the path back to the ground support vehicle for landing 308, as well as a list comprising all the known obstacles within the cube (buildings, bridges, poles, vegetation, etc.). The flight paths may include a buffer zone or maximum deviation area 151, which may be determined by taking into account factors affecting flight performance such as: exterior temperature, mission height, payload, wind speed and direction. Each UAV 11 may resupply 309 at the ground support vehicle 10 or take off 305 at the command of the GCS 130, in an order calculated by the resource manager 133.

The resource manager 133 may allow for the parameters to be constantly optimised 310. The resource manager may be able to demand that the flight paths 150 be modified at any time, accounting for changes in atmospheric conditions due to altitude, the addition or loss of resources such as ground support vehicles or UAVs, the appearance of new fire hotspots or the complete extinguishment of fire hotspots, or the risk of a collision occurring in the future 311. The maximum deviation area 151 around the flight paths may also be optimised according to new developments in the parameters registered by the UAVs 11. The qualified personnel may override 312 the autonomous GCS 130 at any time, commanding a pause or complete shut down of the operation.

Another aspect of the presently disclosed firefighting method involves the interaction between the ground support vehicle 10, which transports all the resources needed for the intervention to the scene of the incident 110, and the UAVs 11. Upon arrival at the scene of the incident, the ground support vehicle 10 may first deploy the hydraulic outrigger 14 in order stabilize the transfer system 12 during the course of the intervention 111. The first UAV 11 may take off at the command of the GCS 130, after the GCS 130 has concluded the preliminary stages; the UAV 11 may engage its four engagement nipple screws 96 with the corresponding zero-point clamping modules 61 situated on the top surface of the container 22. The container 22 may then be picked up from the top deck 41 of the transfer system 12 and the UAV 11 may then ascend to the desired altitude and commence the extinguishing pass 112. The UAV 11 may need to maintain a distance of 20 to 30 m from the surface of the building, so as to avoid overheating and to ensure a correct aim. During the discharge procedure, the UAV 11 may be positioned within the maximum discharge area 152 conceived as an ellipsoid oriented toward the target 153. The water cannon control module 104 may ensure a perpendicular deployment 121 of the water jet on the vertical plane of the targeted fire hotspot 153. The water cannon control module 104 may also compensate for the recoil exerted on the UAV 11 during the high-pressure discharge, by effecting specific manoeuvres which involve pitching forward at a degree determined by the water cannon control module 104, proportional to the expected pressure of the discharged water jet, which may be up to 300 kg. The method may involve two systems with three degrees of freedom; the first system being the UAV 11, specifically the relative base position 122, which may move inside the maximum discharge area 152, the second system being the water cannon 92 itself. The method may seek to orient both systems so as to achieve an optimum 45° angle of attack, by manoeuvring the relative base position 122 horizontally, laterally and vertically with regards to the target 153 and negotiating the α and β, angles so as to achieve a coarse and fine adjustment of the angle of attack.

Each water tank compartment 63 may carry a maximum payload of 1500 litres. The volume flow rate of the on-board water pump 94 may vary between 1000 and 1500 litres/minute. The UAV 11 may have a safe estimated maximum flight time of 14 minutes. The speed at which the UAV 11 may ascend, not accounting for variable atmospheric conditions, may be 4 meters/second. The speed at which the UAV 11 may descend, not accounting for variable atmospheric conditions, may be 4 meters/second. By using specifications such as these, the GCS 130 may deduce the time required for a complete extinguishing pass 112.

In one hypothetical exemplary scenario, the fire is located at a height of 350 meters; therefore, the duration of one extinguishing pass 112 may be calculated at around 6 minutes. The second UAV 11 may therefore be launched after approximately 2 minutes, in order to replace the previous UAV 11 as it concludes the extinguishing procedure 113, if we consider only one ground support vehicle 10 and two associated UAVs 11 to be available. The table below includes the figures for the aforementioned scenario, and a further hypothetical scenario wherein the fire is located at a height of 500 meters:

| | | Duration of | | | Total | |
|---|---|---|---|---|---|---|
| | Duration | extinguishing | Duration of | | duration of | |
| Height | of ascent | procedure | descent | | pass | |
| 350 m | ~2 min | ~2 min | ~1.5 | min | ~6 | min |
| 500 m | ~3 min | ~2 min | ~2 | min | ~6-7 | min |

After depleting its initial water supply, the first UAV 11 may return to dock with the ground support vehicle 10, where it may discard the depleted container on the platform 43 situated on the rear elevator. The previously discarded container 22 may be transported 115 to the bottom deck by the rear elevator. Upon reaching the bottom deck 40, the corresponding hydraulic cylinder 24 may push the platform 43 carrying the discarded container 22 so as to bring its rack segment 45 into alignment with the adjacent platform's 43 rack segment 45. The platforms 43 on the bottom deck 40 may be driven by the bottom pinion 46 along the bottom pair of guideways 42, with the purpose of placing 116 a new platform 43 on the front elevator 21. The front elevator 21 may then ascend 117. Upon reaching the top deck 41, the corresponding hydraulic cylinder 25 may push the platform 43 to bring its rack segment 45 into alignment with the adjacent platform's 43 rack segment 45. The platforms 43 on the top deck 41 may then be driven by the top pinion 49 along the top pair of guideways 42, with the purpose of placing a new platform 43 on the rear elevator. The UAV 11 may then immediately engage with the full container 22, now located on the rear elevator, and continue with the mission 118. The water tank compartment 63 of the container 22 which has reached the designated spot 23 may now be refilled 119 with the aid of the firehose 36. The firehose 36 will engage the lateral valve coupling 35 of the container 22 when actioned by the corresponding pneumatic cylinder 38 located on the corresponding metal profile 39. Each container 22 may receive power provided from the pump/generator assembly 13. The DC link 71 supplies current through the eight power plugs 31; the power plugs 31 are actionable by the corresponding pneumatic cylinder 32, located on each corresponding metal profile 34. This may allow the battery packs, stored within the battery pack compartments 64, to be recharged while the transfer system 12 is stationary. A depleted container 22 may thus be recharged successively by each power plug 31, advancing step by step with each new transfer cycle, while the UAVs 11 are airborne. The water tank compartment 63 of a depleted container 22 may only be refilled once the depleted container 22 reaches the designated spot 23 on the top deck. This procedure is designed to potentially continue for an undetermined period of time, as the depleted containers brought back by the UAVs 11 may be refilled and recharged while the UAVs 11 are airborne.

It will be understood that while exemplary features of an apparatus for control of firefighting apparatus have been described, such an arrangement is not to be construed as limiting the invention to such features. The method(s) for controlling a firefighting apparatus may be implemented in software, firmware, hardware, or a combination thereof. In one mode, the method is implemented in software, as an executable program, and is executed by one or more special or general-purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method for controlling a multi-rotor aircraft. The processor(s) is a hardware device for executing software, particularly software stored in memory. Processor(s) can be any custom made or commercially available processor, a primary processing unit (CPU), an auxiliary processor among several processors associated with a computer, a semiconductor-based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object-oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When any referred to method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing throughput and reducing processing requirements.

1. A firefighting apparatus comprising:
at least one Unmanned Aerial Vehicle (UAV), the at least one UAV comprising engagement means for releasable engagement with a receptacle containing a fire suppressant medium;
a means for releasing or directing the fire suppressant medium from the receptacle;
a ground support base configured to carry a plurality of receptacles;
a control means in operable communication with the at least one UAV;
wherein the control means is configured to receive and/or calculate information in relation to the levels of fire suppressant medium in the receptacle carried by the at least one UAV and to direct the at least one UAV to return to the ground support base to replenish, or deposit and replace, the receptacle should the contents of the receptacle be depleted beyond a threshold value.

2. The firefighting apparatus of claim 1, wherein the ground support base comprises a transfer system.

3. The firefighting apparatus of claim 2, wherein the transfer system is configured to move receptacles between a first position, wherein the at least one UAV may access and engage with at partially replenished receptacles, and a second position wherein the receptacles are positioned for replenishment.

4. The firefighting apparatus of claim 2, wherein the at least one UAV is powered by a rechargeable electric power source, the ground support base comprising recharging means for recharging the rechargeable electric power source.

5. The firefighting apparatus of claim 4, wherein the control means is configured to receive and/or calculate information in relation to the charge levels of the rechargeable electric power source and to direct the at least one UAV to return to the ground support base to recharge should the charge level be depleted beyond a threshold value.

6. The firefighting apparatus of claim 4, wherein the rechargeable electric power source is housed in or on the receptacle and is operably connectable to a motor of the at least one UAV when the UAV is in engagement with the receptacle.

7. The firefighting apparatus of claim 4, wherein, when located on the ground support base, the rechargeable electric power source is engageable with at least one output of the recharging means, the engagement therebetween sufficient in duration to at least partially charge the rechargeable electric power source.

8. The firefighting apparatus of claim 6, wherein the transfer system is configured to move receptacles into at least one charging position, wherein the rechargeable electric power source is in operable engagement with the charging means and charged thereby.

9. The firefighting apparatus of claim 1, wherein the apparatus comprises a plurality of UAV's.

10. The firefighting apparatus of claim 1, wherein the ground support base is configured to refill depleted receptacles deposited by the at least one UAV with fire suppressant medium via a reservoir of fire suppressant medium contained therein, or by an external source thereof in operable connection with the ground support base.

11. The firefighting apparatus of claim 2, wherein the ground support base comprises an upper level, wherein the receptacles are accessible by the at least one UAV, and a lower level wherein the receptacles are refilled, the receptacles being movable between the upper and lower levels by the transfer system.

12. The firefighting apparatus of claim 11, wherein the upper and lower levels of the ground support base comprise elongate decks having first and second longitudinal ends, the upper deck being locatable directly above the lower platform.

13. The firefighting apparatus of claim 12, wherein the transfer system comprises a horizontal transfer means configured to transfer receptacles between longitudinal ends of the upper and decks, the transfer system further comprising vertical transfer means configured to transfer the receptacles between the upper and lower decks.

14. The firefighting apparatus of claim 13, wherein receptacles deposited on the upper level of the ground support base are transferred towards the first longitudinal end thereof before being transferred to first longitudinal end of the lower level by a first vertical transfer means.

15. The firefighting apparatus of claim 14, wherein the receptacles are further transferred from the first end of the lower level to the second end thereof whereat the receptacles are transferred to the second end of the upper level by a second vertical transfer means.

16. The firefighting apparatus of claim 1, wherein the means for releasing or directing the fire suppressant medium from the receptacle is a fire suppressant delivery means comprising a directional control means and a pump for delivering the fire suppressant medium from the receptacle to the directional control means.

17. The firefighting apparatus of claim 16, wherein the directional control means is a nozzle, the nozzle and the pump being in operable communication with the control means.

18. The firefighting apparatus of claim 3 or claim 4, wherein the control means comprises a processor and a storage medium, the storage medium having software modules storable thereon which are executable by the processor to control at least the operations in relation to replenishment or replacement of receptacles.

19. The firefighting apparatus of claim 18, wherein the storage medium has software modules storable thereon which are executable by the processor to control the operations in relation to the recharging of the rechargeable electric power source, and the directing of fire suppressant medium from the receptacle.

20. The firefighting apparatus of claim 19, wherein the storage medium further comprises software modules storable thereon which are executable by the processor to control aspects of the planning of firefighting activities, flight operations of the at least one UAV, and/or control of execution of firefighting activities.

21. The firefighting apparatus of claim 1, wherein the at least one UAV comprises a plurality of rotors, the at least one UAV further comprising a Flight Management Unit (FMU) in operable engagement with each rotor and configured to control the thrust levels thereof during standard air manoeuvres, the FMU being in operable communication with thrust level sensors configured to measure the thrust of the rotors.

22. The firefighting apparatus of claim 21, wherein the FMU will monitor and adjust the thrust of each rotor such that correct attitude of the aircraft is maintained.

23. The firefighting apparatus of claim 21, wherein the FMU is configured to carry out calculations involved in navigation.

24. The firefighting apparatus of claim 21, wherein the FMU is in operable engagement with a means for detecting forces or changes in attitude experienced by the at least one UAV as a result of releasing or directing fire suppressant therefrom, the FMU configured to counter such forces or changes in attitude by adjustment of the thrusts of one or more of the rotors.

25. The firefighting apparatus of claim 21, wherein the FMU comprises a processor and a storage medium having software modules storable thereon, the software modules being executable by the processor.

26. The firefighting apparatus of claim 1, wherein the ground support base is a mobile ground support base which is utilised to transport the receptacles and/or the at least one UAV to the site of a fire.

27. An Unmanned Aerial Vehicle (UAV) for use in a firefighting apparatus, the UAV comprising:
a plurality of rotors;
engagement means for releasable engagement with a receptacle containing a fire suppressant medium;
a means for releasing or directing the fire suppressant medium from the receptacle;
a Flight Management Unit (FMU) configured to control the thrust levels of the plurality of rotors during at least standard air manoeuvres;
the UAV being in operable communication with a control means;
wherein the control means is configured to receive information in relation to the levels of fire suppressant medium in the receptacle carried by the at least one UAV and to direct the at least one UAV to return to a ground support base to replenish, or deposit and replace, the receptacle should the contents of the receptacle be depleted beyond a threshold value.

28. A ground support base for use in a firefighting apparatus employing at least one Unmanned Aerial Vehicle (UAV), the ground support base being configured to carry a plurality of receptacles for containing fire suppressant medium and comprising a transfer system configured to move receptacles between a first position, wherein the at least one UAV may access and engage with at partially replenished receptacles, and a second position wherein the receptacles are positioned for replenishment.

29. A control means for a fire fighting apparatus employing at least one Unmanned Aerial Vehicle (UAV), the UAV being configured for releasable engagement with a receptacle containing a fire suppressant medium, the control means comprising a processor and a storage medium, the storage medium having software modules storable thereon which are executable by the processor to control at least the operations in relation to replenishment or replacement of the receptacle.

30. A method of firefighting comprising the steps of:
delivering one or more firefighting Unmanned Aerial Vehicles (UAVs) and one or more receptacles containing fire suppressant to the site of the fire;
the one or more UAVs engaging with a receptacle containing a fire suppressant medium and carrying the engaged receptacle to a location of the fire before depositing the fire suppressant medium in a manner which acts to at least partially extinguish or suppress the fire;
a control means receiving information in relation to the levels of fire suppressant medium in the receptacle carried by the at least one UAV and to directing the at least one UAV to return to a ground support base to replenish, or deposit and replace the receptacle should the contents of the receptacle be depleted beyond a threshold value.

31. The method of claim 30 further comprising the ground support base replenishing the depleted receptacles once deposited thereon by the UAV's, the ground support base positioning the replenished receptacles for engagement with the one or more UAV's.

32. The method of claim 32, wherein UAV's return to the ground support base to deposit a depleted receptacle and engage with a replenished receptacle until the fire is satisfactorily extinguished or suppressed.

33. A computer-readable medium comprising non-transitory instructions which, when executed, cause a processor to carry out a method according to any one of claims 30 to 32.
